(19) United States
(12) Patent Application Publication
(10) Pub. No.: US 2011/0068066 A1
(43) Pub. Date: Mar. 24, 2011

(54) DEVICE FOR HOLDING AND DISPLAYING MERCHANDISE AND MERCHANDISING METHOD

(76) Inventor: Selim DUSHEY, Brooklyn, NY (US)

(21) Appl. No.: 12/562,315

(22) Filed: Sep. 18, 2009

(51) Int. Cl. A47F 7/00; B23P 11/00

(52) U.S. Cl. 211/59.2; 29/428

(57) ABSTRACT

A merchandising device includes a suspension portion for suspending the device in a display position, a plurality of branch portions respectively attached to, for joint movement with, a corresponding plurality of items of merchandise, and a connecting portion for interconnecting the suspension portion and the branch portions, and for jointly holding the branch portions and the respectively attached items apart at a predetermined spacing in a side-to-side relation to display the items, in the display position. The connecting portion is further operative for enabling the branch portions and the respectively attached items to be jointly moved apart to a greater spacing than the predetermined spacing to a use position in which the items are accessible to be used, and to be jointly moved together to return to the predetermined spacing after the items have been used. The branch portions remain attached to the items during movement between the positions.

### BACKGROUND OF THE INVENTION

The present invention generally relates to a device for, and a method of, holding and displaying items of merchandise, for example, shoes.

In many sales outlets, such as supermarkets, department stores, sports goods stores, shoe stores and discount retailers, shoes are not sold in pairs in shoeboxes, but are generally placed loosely on open shelves or in bulk bins without being packaged. This leads to disorder as a customer must hunt for two shoes of the same size and style to try on. To prevent such disorder, the art has proposed tying each pair of shoes together by, for example, a fine plastic thread. However, such threads can be cut, again leading to customer frustration.

Shoe hangers have also been widely used to hang shoes in a vertical display orientation in pairs on a support fixture, such as a display rack having pegs. Each shoe hanger typically comprises an upper hook for suspension from a peg, and two lateral support elements on which a pair of shoes is mounted. Although relatively inexpensive and practical, experience with such shoe hangers has shown that, when the customer wishes to try on a pair of shoes, the shoes must be completely removed and dismounted from their hanger. After the customer has tried on a pair of shoes which does not suit him or her, many customers do not mount the shoes back on their shoe hanger. Therefore, not only the shoes, but also the shoe hangers are in disorder. Similarly, experience has shown that many shoe hangers are abandoned in the aisles of the retail outlet after the customer has taken the chosen shoes.

To prevent detachment between the shoes and their hangers, the art has further proposed, for example, in European Patent Application No. 1,421,880 and U.S. Pat. No. 5,282,553, the use of ties to fasten the shoes to their hangers. As advantageous as such ties have been in preventing the shoes from becoming disconnected from their hangers, the ties render it difficult to allow the shoes to be easily tried on. The shoes must still be dismounted and removed from lateral support elements on their hanger to allow the shoes to be easily tried on, and the shoes must still be re-mounted on the lateral support elements after the shoes have been tried on.

### SUMMARY OF THE INVENTION

One aspect of this invention is directed to a merchandising device that includes a suspension portion for suspending the device in a display position, a plurality of support or branch portions respectively attached to, for joint movement with, a corresponding plurality of items of merchandise, and a connecting portion for interconnecting the suspension portion and the branch portions, and for jointly holding the branch portions and the respectively attached items apart at a predetermined spacing in a side-to-side relation to display the items, in the display position. The connecting portion is further operative for enabling the branch portions and the respectively attached items to be jointly moved apart to a greater spacing than the predetermined spacing to a use position in which the items are accessible to be used, and to be jointly moved together to return to the predetermined spacing after the items have been used. The branch portions remain attached to the items during movement between the positions. The joint movement of the branch portions and the respectively attached items between the display and use positions allows the items to be easily used and, if the items are shoes, to be easily tried on one's feet. In contrast to the prior art, the shoes are not dismounted and removed from any lateral support elements on the device to allow the shoes to be easily tried on, and the shoes are not re-mounted on any lateral support elements after the shoes have been tried on.

The suspension portion may advantageously be a hook, such as a curved C-shaped or a T-shaped hook, or a mounting hole for engaging a display fixture, such as a peg or projection extending outwardly from a rack or shelf in a retail outlet, or any means for suspending the device, preferably in a vertical orientation. The branch portions may advantageously be any support portions attached to the items, for example, substantially planar panels mounted in surface area contact with the respectively attached items. The branch portions may be glued, bonded, or otherwise connected, for example, by a hook-and-loop fastener, to the items. No matter how they are connected, the connection is not permanent; the branch portions can be separated or peeled away from the items after a customer has purchased the items.

In a preferred embodiment, the connecting portion includes a detachable fastener between the branch portions. The fastener is operative for fully detaching one of the branch portions and its respectively attached item from the device in the use position. The fastener includes a pair of fastener parts respectively connected to the branch portions. The fastener parts are connected to each other in the display position, and are disconnected from each other in the use position. The suspension portion is preferably integral with one of the fastener parts. Advantageously, the connecting portion includes a plurality of such detachable fasteners, each fastener being located between a pair of the branch portions.

In another preferred embodiment, the connecting portion is integral with the branch portions and together comprise a foldable sheet, preferably constituted of a heavy duty sheet material, such as cardboard or plastic, and having multiple substantially planar panels foldable about fold lines. A plurality of the panels are mounting panels mounted in surface area contact with the respectively attached items. Others of the panels are connecting panels connected between the mounting panels. The connecting panels fold into surface area contact onto each other in the display position, and unfold to lie in a common plane in the use position.

Still another aspect of this invention is directed to a method of merchandising items of merchandise. The method is performed by respectively attaching a plurality of support or branch portions to, for joint movement with, a corresponding plurality of the items of merchandise; jointly holding and suspending the branch portions and the respectively attached items apart at a predetermined spacing in a side-to-side relation to display the items in a display position; jointly moving the branch portions and the respectively attached items apart to a greater spacing than said predetermined spacing to a use position in which the items are accessible to be used; jointly moving the branch portions and the respectively attached items together to return to said predetermined spacing after the items have been used; and maintaining the branch portions attached to the items during movement between said positions. The joint movement of the branch portions and the respectively attached items between the display and use positions allows the items to be easily used and, if the items are shoes, to be easily tried on one's feet.

The holding step is preferably performed by mounting the branch portions in surface area contact with the respectively attached items. In one embodiment, the step of moving the branch portions to the use position is performed by fully detaching one of the branch portions and its respectively attached item from another of the branch portions and its respectively attached item. In another embodiment, the step of moving the branch portions to the use position is performed by unfolding one of the branch portions to lie in a common plane with another of the branch portions.

The items need not be shoes, and the invention is not intended to be restricted to shoes, because it can equally well cover items or products of any type, for example, other items that come in pairs, such as gloves, or even unrelated items, as well as items that do not come in pairs.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of one embodiment of a merchandising device for holding and displaying items of merchandise in a display position in accordance with the method of this invention;

FIG. 2 is an enlarged front elevational view of the device of FIG. 1, with the items shown in phantom lines;

FIG. 3 is a view analogous to FIG. 1, but with the device in a use position;

FIG. 4 is a sectional view taken on line 4-4 of FIG. 2;

FIG. 5 is a perspective view of another embodiment of a merchandising device for holding and displaying items of merchandise in a display position in accordance with the method of this invention;

FIG. 6 is a perspective view of the device of FIG. 5 during movement to a use position;

FIG. 7 is a perspective view of the device of FIG. 5 in the use position;

FIG. 8 is a front view of still another embodiment of a merchandising device for holding and displaying items of merchandise, shown in broken-away view, in a display position in accordance with the method of this invention; and

FIG. 9 is a front view of yet another embodiment of a merchandising device for holding and displaying items of merchandise, shown in broken-away view, in a display position in accordance with the method of this invention;

### DETAILED DESCRIPTION OF THE PREFERRED EMBODIMENTS

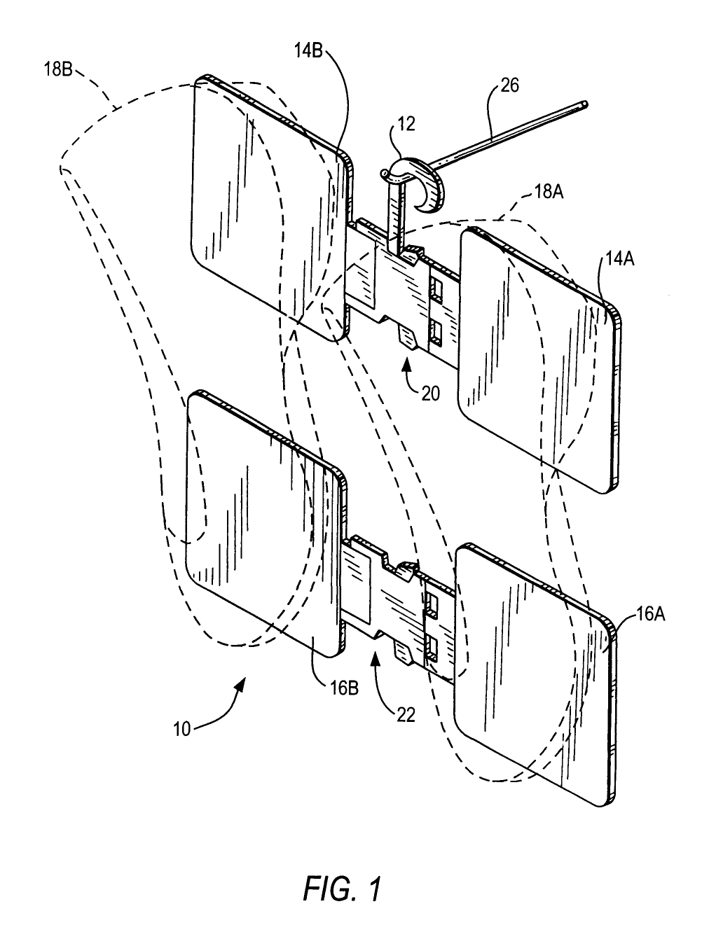

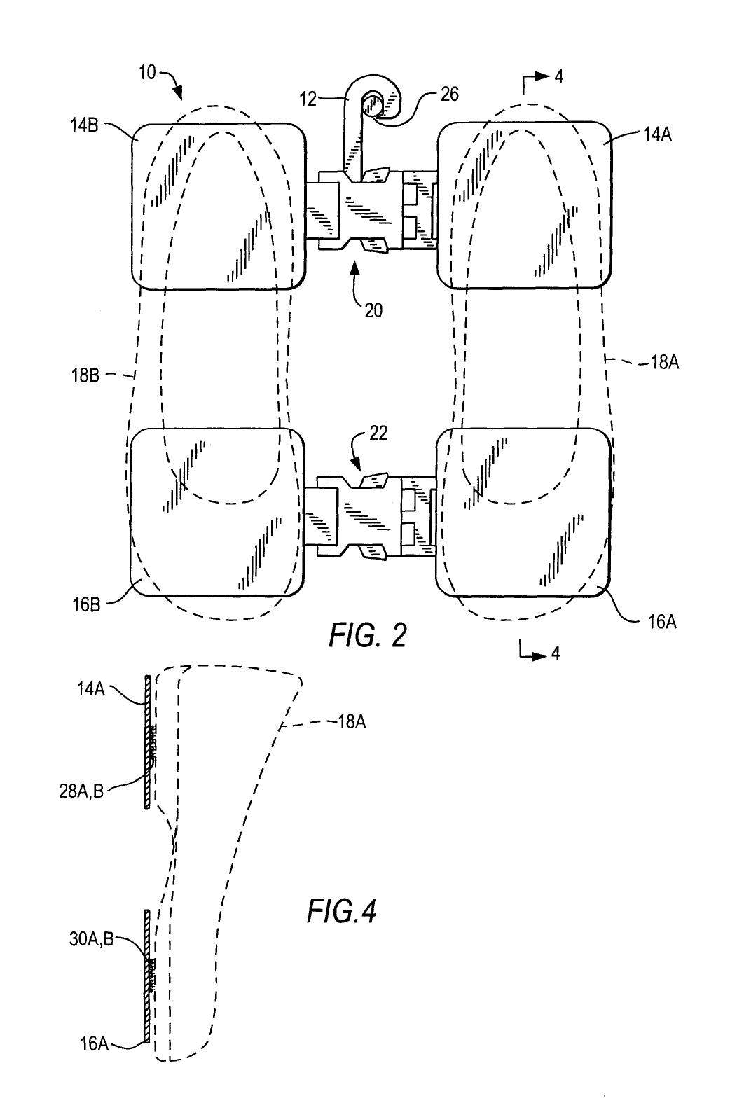

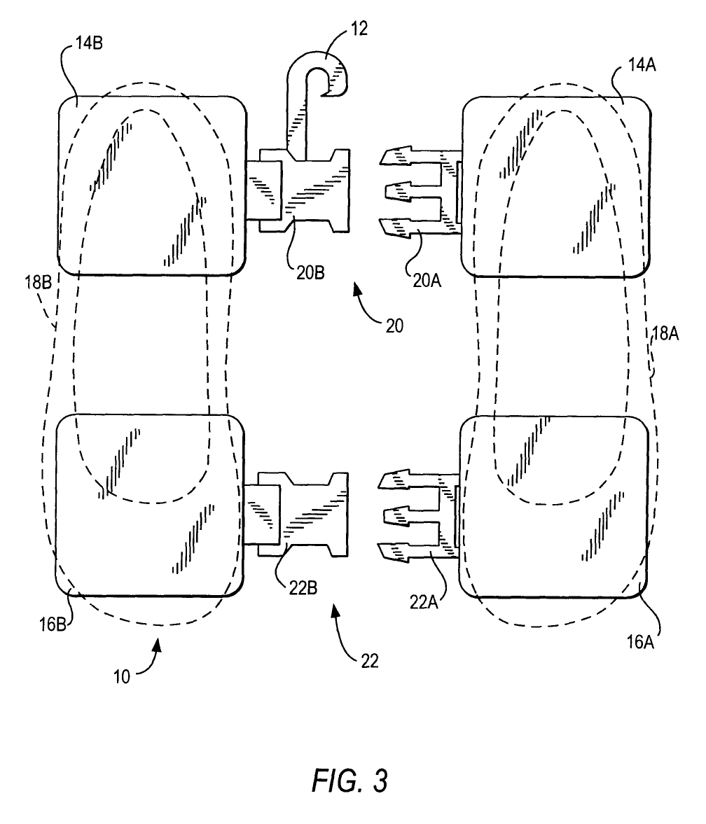

Referring now to FIG. 1 of the drawings, reference numeral 10 generally identifies a merchandising device that includes a suspension portion 12 for suspending the device 10 in a display position (see FIGS. 1-2), a plurality of support or branch portions 14A, 14B; 16A, 16B respectively attached to, for joint movement with, a corresponding plurality of items of merchandise, for example, a pair of shoes 18A, 18B, and a connecting portion 20, 22 for interconnecting the suspension portion 12 and the branch portions 14A, 14B; 16A, 16B, and for jointly holding the branch portions 14A, 14B; 16A, 16B and the respectively attached items 18A, 18B apart at a predetermined spacing in a side-to-side relation to display the items 18A, 18B, in the display position of FIGS. 1-2. The connecting portion 20, 22 is further operative for enabling the branch portions 14A, 14B; 16A, 16B and the respectively attached items 18A, 18B to be jointly moved apart to a greater spacing than the predetermined spacing to a use position (see FIG. 3) in which the items 18A, 18B are accessible to be used, and to be jointly moved together to return to the predetermined spacing after the items 18A, 18B have been used. The branch portions 14A, 14B; 16A, 16B remain attached to the items 18A, 18B during movement between the positions. The joint movement of the branch portions 14A, 14B; 16A, 16B and the respectively attached items 18A, 18B between the display and use positions allows the items 18A, 18B to be easily used and, if the items are shoes, to be easily tried and worn on one's feet. In contrast to the prior art, the shoes are not dismounted and removed from any lateral support elements on the device to allow the shoes to be easily tried on, and the shoes are not re-mounted on any lateral support elements after the shoes have been tried on.

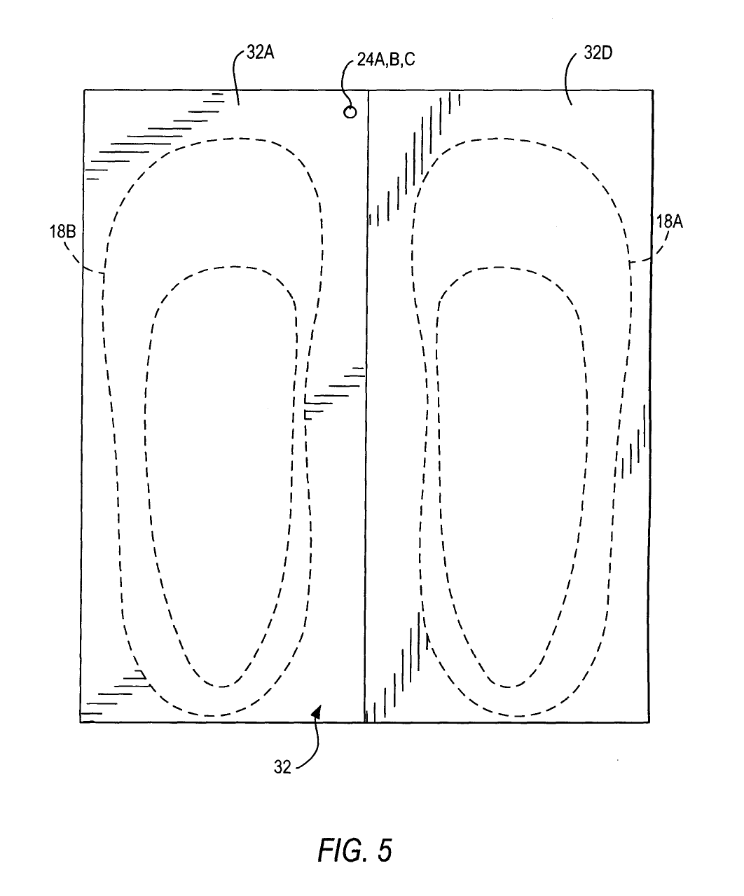

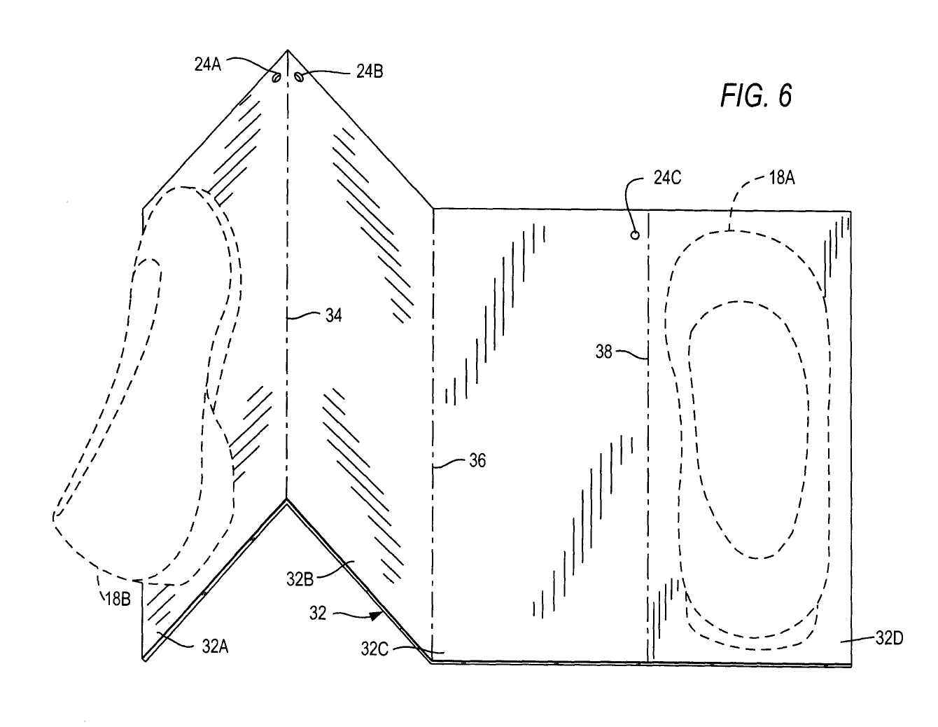

The suspension portion 12 may advantageously be a curved, C-shaped hook as shown in the embodiment of FIGS. 1-3, or any hook, such as a T-shaped hook, or a mounting hole, or a series of aligned mounting holes 24A, 24B, 24C as shown in the embodiment of FIGS. 5-7 for engaging a display fixture, such as a peg or projection 26 extending outwardly from a rack or shelf in a retail outlet, or any means for suspending the device, preferably in a vertical orientation. The branch portions 14A, 14B; 16A, 16B may advantageously be any support portions attached to the items, for example, substantially planar panels, as shown in the embodiment of FIGS. 1-3, mounted in surface area contact with the respectively attached items 18A, 18B. In the illustrated case of shoes, the panels are attached to outsoles of the shoes. Preferably, the branch portions 14A, 14B are attached to forward parts of the outsoles, and the branch portions 16A, 16B are attached to rearward parts of the outsoles. The branch portions may be glued, bonded, or otherwise connected, for example, as shown best in FIG. 4, by a pair of hook-and-loop fastener strips 28A, 28B; 30A, 30B to the items. No matter how they are connected, the connection is not permanent; the panels can be separated or peeled away from the items 18A, 18B after a customer has purchased the items 18A, 18B. If a glue or bonding agent is used, then it is advantageous to use an aggressive adhesive that is nevertheless peelable by pulling on a pull tab.

In the embodiment of FIGS. 1-3, the connecting portion 20, 22 includes at least one detachable fastener, and preferably a plurality of such detachable fasteners, between the branch portions 14A, 14B; 16A, 16B. The fasteners or connecting portions 20, 22 are operative for fully detaching the branch portions 14A, 16A and their respectively attached item 18A from the device 10 in the use position. The fastener 20 is a buckle-type fastener and includes a pair of fastener parts 20A, 20B respectively connected to the branch portions 14A, 14B. The fastener 22 is also a buckle-type fastener and includes a pair of fastener parts 22A, 22B respectively connected to the branch portions 16A, 16B. The fastener parts 20A, 20B; 22A, 22B are connected to each other in the display position, and are disconnected from each other in the use position. The suspension portion 12 is preferably integral with the fastener part 20B. The fastener parts 20B, 22B may be made integral with each other, and the fastener parts 20A, 22A may also be made integral with each other.

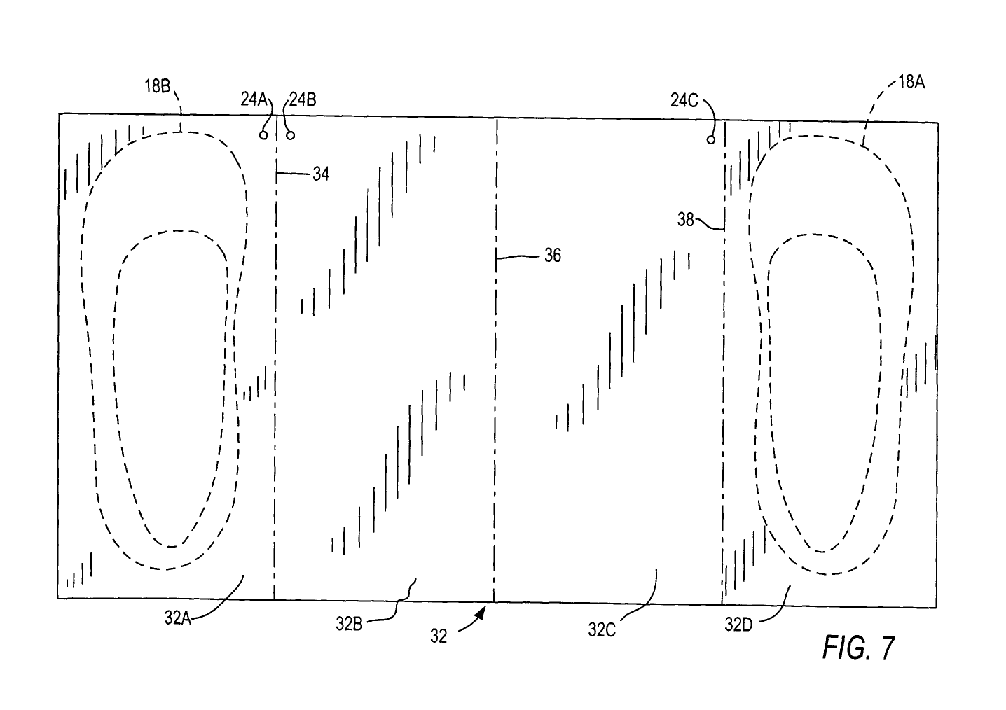

In the embodiment of FIGS. 5-7, the connecting portion is integral with the branch portions and together comprise a foldable sheet 32, preferably constituted of a heavy duty sheet material, such as cardboard or plastic, and having multiple substantially planar panels 32A, 32B, 32C, 32D foldable about fold lines 34, 36, 38. A plurality of the panels are mounting panels 32A, 32D mounted in surface area contact with the respectively attached items 18A, 18B in the same manner as described above. Others of the panels 32B, 32C are connecting panels 32B, 32C connected between the mounting panels 32A, 32D. The connecting panels 32B, 32C fold about fold lines 34, 36 into surface area contact onto each other in the display position (FIG. 5), and unfold to lie in a common plane in the use position (FIG. 7). Upon comparing the spacing between the items 18A, 18B, it will be observed that the spacing between the items 18A, 18B is greater in FIG. 3 and FIG. 7 to make it easier for a user to access and use the items, whereas the spacing between the items 18A, 18B is smaller in corresponding FIG. 2 and FIG. 5 to make the display more compact.

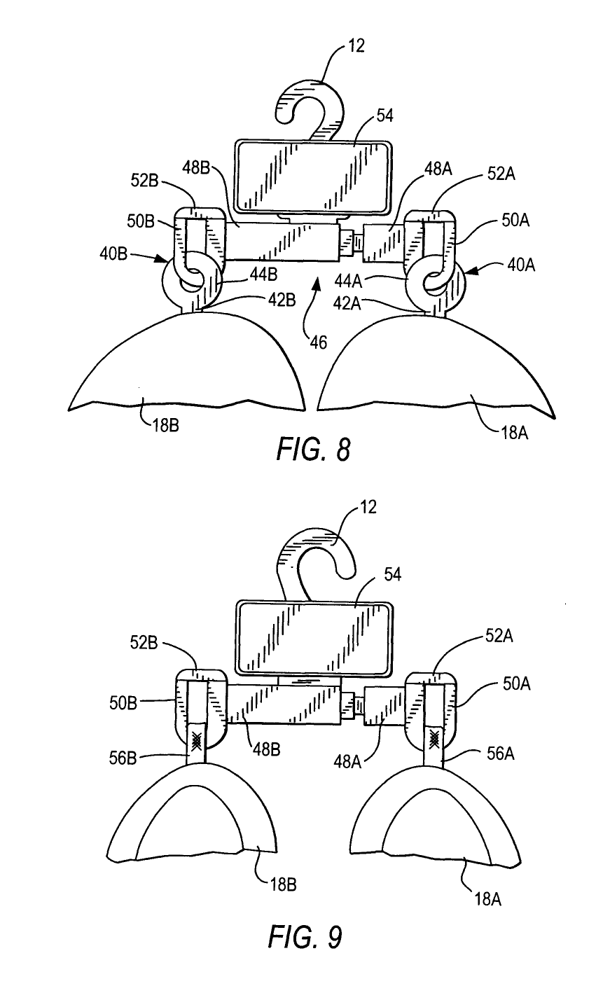

In the embodiment of FIG. 8, the branch portions 40A, 40B are configured as apertured tabs having tab portions 42A, 42B attached, preferably adhesively, to the items 18A, 18B and apertured portions 44A, 44B extending away from the tab portions 42A, 42B. As shown, the tab portions 42A, 42B are attached on toe portions of outsoles of the items 18A, 18B, but it will be understood that the tab portions 42A, 42B could be attached at heel portions of the outsoles, or anywhere else on the items 18A, 18B. The apertured portions 44A, 44B are shown as generally circular loops with circular holes, but other shapes are contemplated by this invention.

A connecting portion 46 interconnects the suspension portion 12 and the branch portions 40A, 40B. The connecting portion 46 includes a pair of mating fastener portions 48A, 48B respectively connected to generally U-shaped yokes 50A, SOB having legs that pass through the holes in the apertured portions 44A, 44B. A pair of lock bars 52A, 52B span the legs on each yoke 50A, 50B and lock the apertured tabs 40A, 40B and the items 18A, 18B on the fastener portions 48A, 48B. A header panel 54 is integral with the suspension portion 12 and the fastener portions 48A, 48B and advantageously bears advertising material and information relating to the items 18A, 18B. The fastener portions 48A, 48B are fastened together, as shown, in the display position, typically by a snap-action fit, and are unfastened in the use position.

The embodiment of FIG. 9 is analogous to that of FIG. 8 and like parts have been identified with like reference numerals, except that rather than using the apertured portions 44A, 44B, a pair of looped tabs 56A, 56B on the items 18A, 18B are used. The looped tabs 56A, 56B are advantageously looped pieces of fabric, typically sewn at the backs of shoes to aid a wearer to pull the shoes onto one's feet, but can be attached anywhere on the shoes, for example, at the arched regions of the shoes to bear information related to the shoes. The lock bars 52A, 52B span the legs on each yoke 50A, 50B and lock the looped tabs 56A, 56B and the items 18A, 18B on the fastener portions 48A, 48B. In the embodiment of FIG. 9, the yokes 50A, 50B serve as the branch portions.

Still another aspect of this invention is directed to a method of merchandising items 18A, 18B of merchandise. The method is performed by respectively attaching the plurality of branch portions 14A, 14B; 16A, 16B; 40A, 40B; 50A, 50B to, for joint movement with, the corresponding plurality of the items 18A, 18B of merchandise; jointly holding and suspending the branch portions 14A, 14B; 16A, 16B; 40A, 40B; 50A, 50B and the respectively attached items 18A, 18B apart at the predetermined spacing in a side-to-side relation to display the items 18A, 18B in the display position; jointly moving the branch portions 14A, 14B; 16A, 16B; 40A, 40B; 50A, 50B and the respectively attached items 18A, 18B apart to the greater spacing than said predetermined spacing to the use position in which the items 18A, 18B are accessible to be used; jointly moving the branch portions 14A, 14B; 16A, 16B; 40A, 40B; 50A, 50B and the respectively attached items 18A, 18B together to return to said predetermined spacing after the items 18A, 18B have been used; and maintaining the branch portions 14A, 14B; 16A, 16B; 40A, 40B; 50A, 50B attached to the items 18A, 18B during movement between said positions. The joint movement of the branch portions 14A, 14B; 16A, 16B; 40A, 40B; 50A, 50B and the respectively attached items 18A, 18B between the display and use positions allows the items 18A, 18B to be easily accessed and used.

The holding step is preferably performed by mounting the branch portions 14A, 14B; 16A, 16B; 40A, 40B in surface area contact with the respectively attached items 18A, 18B. In the embodiment of FIGS. 1-3, the step of moving the branch portions 14A, 14B; 16A, 16B to the use position is performed by fully detaching the branch portions 14A, 16A and their respectively attached item 18A from the branch portions 14B, 16B and their respectively attached item 18B. In the embodiment of FIGS. 5-7, the step of moving the branch portions to the use position is performed by unfolding one of the branch portions to lie in a common plane with another of the branch portions. In the embodiment of FIGS. 8-9, the step of moving the branch portions 40A, 40B; 50A, 50B to the use position is performed by fully detaching the fastener portions 48A, 48B.

A main feature of this invention is to have the branch portions move apart, either by full separation from the device, or by enabling lateral movement of the branch portions apart from each other. The consumer is able to try on and use the spaced-apart items while the device, or at least portions thereof, are still attached to the items. In this way, the device, or at least portions thereof, are readily available on the items to put the items back on display. In contrast to the prior art, the items are not removed from any lateral support elements on the device to allow the items to be used, and the items are not re-mounted on any lateral support elements after the items have been used.

It will be understood that each of the elements described above, or two or more together, also may find a useful application in other types of constructions differing from the types described above. For example, the items 18A, 18B need not be shoes, and the invention is not intended to be restricted to shoes, because it can equally well cover items or products of any type, for example, other items that come in pairs, such as gloves, or even unrelated items, as well as items that do not come in pairs. In addition, the fasteners 20, 22 need not be two buckle-type fasteners, because can equally well be different types of fasteners, as well as a different number of fasteners. Also, the sheet 32 need not be a double-fold sheet having four panels, but can have more or fewer folds and more or fewer panels. The panels 32A, 32D need not extend past the length and width of the items as illustrated, but can terminate short of the length and width of the items. The panels 32B, 32C could even be eliminated and replaced by tethers, especially stretchable bands, that extend between the panels 32A, 32D. Furthermore, when the items 18A, 18B are shoes, they need not be connected solely to the outsoles as illustrated in FIGS. 1-8, but could be connected anywhere to the shoes, for example, on back pull tabs commonly found on many styles of shoes, as illustrated in FIG. 9. Also, the number of branch portions need not be two or four as described above, but can be a different number of branch portions.

While the invention has been illustrated and described as embodied in a merchandising device for, and a method of, merchandise items of merchandise, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A merchandising device, comprising:
a suspension portion for suspending the device in a display position;
a plurality of branch portions respectively attached to, for joint movement with, a corresponding plurality of items of merchandise; and
a connecting portion for interconnecting the suspension portion and the branch portions, and for jointly holding the branch portions and the respectively attached items apart at a predetermined spacing in a side-to-side relation to display the items, in the display position,
the connecting portion being further operative for enabling the branch portions and the respectively attached items to be jointly moved apart to a greater spacing than said predetermined spacing to a use position in which the items are accessible to be used, and to be jointly moved together to return to said predetermined spacing after the items have been used, the branch portions remaining attached to the items during movement between said positions.

2. The device of claim 1, wherein the suspension portion is a hook for engaging a display fixture.

3. The device of claim 1, wherein the suspension portion is a mounting hole for engaging a display fixture.

4. The device of claim 1, wherein the branch portions are mounted in surface area contact with the respectively attached items.

5. The device of claim 1, wherein the branch portions are hooked to the respectively attached items.

6. The device of claim 1, wherein the connecting portion includes a detachable fastener between the branch portions, and operative for fully detaching one of the branch portions and its respectively attached item from the device in the use position.

7. The device of claim 6, wherein the fastener includes a pair of fastener parts respectively connected to the branch portions, wherein the fastener parts are connected to each other in the display position, and wherein the fastener parts are disconnected from each other in the use position.

8. The device of claim 7, wherein the suspension portion is integral with one of the fastener parts.

9. The device of claim 1, wherein the connecting portion includes a plurality of detachable fasteners, each fastener being located between a pair of the branch portions.

10. The device of claim 1, wherein the connecting portion is integral with the branch portions and together comprise a foldable sheet having multiple substantially planar panels foldable about fold lines, and wherein a plurality of the panels are mounting panels mounted in surface area contact with the respectively attached items.

11. The device of claim 10, wherein others of the panels are connecting panels connected between the mounting panels. and wherein the connecting panels fold into surface area contact onto each other in the display position, and unfold to lie in a common plane in the use position.

12. The device of claim 9, wherein the sheet is constituted of a heavy duty sheet material.

13. A method of merchandising items of merchandise, comprising the steps of:
respectively attaching a plurality of branch portions to, for joint movement with, a corresponding plurality of the items of merchandise;
jointly holding and suspending the branch portions and the respectively attached items apart at a predetermined spacing in a side-to-side relation to display the items in a display position;
jointly moving the branch portions and the respectively attached items apart to a greater spacing than said predetermined spacing to a use position in which the items are accessible to be used;
jointly moving the branch portions and the respectively attached items together to return to said predetermined spacing after the items have been used; and
maintaining the branch portions attached to the items during movement between said positions.

14. The method of claim 13, wherein the holding step is performed by mounting the branch portions in surface area contact with the respectively attached items.

15. The method of claim 13, wherein the holding step is performed by hooking the branch portions to the respectively attached items.

16. The method of claim 13, wherein the step of moving the branch portions to the use position is performed by fully detaching one of the branch portions and its respectively attached item from another of the branch portions and its respectively attached item.

17. The method of claim 13, wherein the step of moving the branch portions to the use position is performed by unfolding one of the branch portions to lie in a common plane with another of the branch portions.

18. The method of claim 13, wherein the step of moving the branch portions to the display position is performed by folding one of the branch portions to lie in surface area contact with another of the branch portions.
